(19) United States
(12) Patent Application Publication
(10) Pub. No.: US 2004/0231598 A1
(43) Pub. Date: Nov. 25, 2004

(54) Electrostatic coater and method for forming prepregs therewith

(76) Inventor: Eran Werner, Kvar Vradim (IL)

Correspondence Address: Abelman Frayne & Schwab, 150 East 42nd Street, New York, NY, 10017-5612, US

(21) Appl. No.: 10/489,080

(22) PCT Filed:
(86) PCT No.: PCT/IL02/00763

(30) Foreign Application Priority Data
Sep. 16, 2001 (IL) 145464

(51) Int. Cl. C23C 16/00

(52) U.S. Cl. 118/723 R

(57) ABSTRACT

An acceleration cell for use in coating substrates with plastic resin particles. The cell includes a housing that has an air inlet port, an air outlet port, and a particle feed port, the latter in association with a resin particle source. The housing receives a carrier airflow for taking up resin particles so that the particles are suspended in the carrier flow. The air outlet port has a configuration having a predetermined width, which generally corresponds to the width of the substrate. The cell also contains at least one electrostatic charger for charging the suspended resin particles and at least one apparatus for accelerating the carrier flow and the suspended particles. Finally, the cell includes at least one flow-modifying apparatus for modifying the resin particle outflow, producing a uniform delivery of the particles across the substrate.

### FIELD OF THE INVENTION

The present invention relates to an apparatus, system and method for electrostatically coating substrates with resins for use as prepregs in producing composite materials.

### BACKGROUND OF THE INVENTION

A prepreg is a substrate pre-impregnated with a matrix resin that binds together the fibers of the substrate. Prepregs are precursor materials that can be used to make finished composite components for inclusion in a wide range of applications, such as airplane structures, medical products, printed circuit boards, industrial components, recreational products and commercial vehicles. In general, composites have advantages over competing materials such as metals. Among other attributes, prepregs generally have higher specific strength, better corrosion resistance, and allow for faster assembly.

The use of composite components made from advanced thermoplastic prepregs is relatively recent. Composites are available in a wide range of substrates and thermoplastic resins. The substrate is often a carbon, glass or aramide substrate, while typical resins include polyethylene (PE), polypropylene (PP), polyetheretherketone (PEEK), polyethersulfone (PES), polyphenylsulfone (PPS), polyimide (PI), polyamides (PA), polycarbonate (PC), polyethylene terephthalate (PET), polyurethane (PU), polyester and fluoropolymers. Thermoplastic prepreg fabrics typically have inherent toughness, good viscoelastic damping, indefinite shelf life, chemical resistance, assembly flexibility and recycling capabilities.

Thermoplastic prepregs can be prepared using solvent impregnation, hot melt coating, film stacking, as well as other methods. However, chemical resistance of the resin often makes solvent impregnation difficult. Hot melt coating, a process similar to pultrusion, requires resins with moderate to high viscosity and melt temperatures. In addition, it often requires high-pressure pumps and resin meters.

Film stacking uses thin films of dry thermoplastic resins that are sandwiched or stacked together with the fabric. After sandwiching, the stack is consolidated under heat and pressure. While this method is clean and solvent-free, consolidation must be carefully carried out to fully impregnate the fabric. The cost of these thin film resins is often relatively high, especially when resins like PEEK and PPS are employed.

Dry powder deposition methods, primarily the electrostatic fluidized bed (EFB) method, are at least 30 years old. Their use obviates the processing difficulties of wet systems (wetting, flow, and homogeneity). In the EFB method, powdered resin particles are aerated in a fluidized chamber and are electrostatically charged by ionized air forced through a porous plate at the base of the chamber. As the powder particles are charged, they repel each other to such a degree that they rise above the chamber forming a low-velocity, essentially uniform cloud of charged particles.

When a substrate is passed over or conveyed through this cloud, the charged powder particles are attached to it because of the potential difference between the particles and substrate. As the particles become attached to the substrate, the particles form a coating whose thickness and deposition rates are controlled both by the magnitude of the applied voltage in the air ionization process and by the exposure time of the substrate to the cloud. Because of the large potential difference between the charging media and most substrates, even natural insulators can be coated. Once coated with particles, the substrate is transported through an oven where the powder melts, flowing over the substrate.

Reference is now made to FIG. 1 where a schematic illustration of a typical prior art EFB coating apparatus 110 is presented. It is composed of a dry air input 12 through which dry air enters into an air plenum chamber 14. The latter is situated under a charging medium (plate) 16 that is connected to a high-voltage DC power supply 18. The incoming dry air is blown past charging medium 16 and through porous plate 20 on which powdered resin is placed. The charged air transfers charge to the powdered resin and forms a low-velocity cloud of charged particles 22 that attaches itself to a grounded substrate 24.

While FIG. 1 shows an object being electrostatically coated, it is readily apparent to one skilled in the art that fabric, tow, tube, tape or fiber substrates can also be coated when such substrates are drawn between two fluidized beds disposed symmetrically on either side of the substrate. FIG. 1 does not show the heating apparatus that melts the polymer resin particles electrostatically attached to the substrate. Typical substrates that can be coated by such an apparatus are fiberglass, carbon fibers and aramide materials.

There are drawbacks to the EFB method. Difficulties exist because the porous plate in fluidized bed coating systems often becomes blocked, resulting in a non-uniform distribution of the charged powder across the coated substrate. In addition, the holes in EFB porous plates can never be fabricated with sufficient uniformity to ensure homogeneity of the coating. Moreover, low-velocity particles generally coat only the surface of a substrate and cannot penetrate into the spaces or interstices of the substrate. Prepregs produced by this method have relatively high resin coating loads. As a result, when such coated fabrics are used to form composites, the composite layers do not adhere to each other uniformly and the composites are generally of low quality.

### Definitions

Except where noted otherwise, in what is discussed herein, the following terms will be used with the following meanings:

Substrate—fabric, often a web-type fabric, fiber, strand or tow material. In certain instances, the word “fabric” may be used to indicate any type of substrate.

Tow—a bundle of untwisted continuous filaments.

Strand—twisted continuous filaments.

Prepreg—a substrate pre-impregnated with a matrix resin, the resin acting to bind together the fibers of the substrate.

Composite—two or more layers of prepregs to which heat and pressure have been applied, thereby causing the matrix resin in the several prepreg layers to fuse and form an integral object.

Resin load—the mass of resin deposited per unit area or per unit mass of substrate.

### SUMMARY OF THE PRESENT INVENTION

Applicant has realized that an apparatus, herein called an “acceleration cell,” emitting charged resin powder at high velocity (“forced flow”), that does not include a porous plate and has a wide aperture, solves many of the problems found in the prior art. Applicant has determined that such a cell produces a uniform coating with lower resin loads, as well as increased resin powder penetration of the substrate. The cell can employ either frictional or high-voltage direct current (DC) power source methods to charge the resin powder. Alternatively, a single acceleration cell can use both methods simultaneously. Systems using a plurality of such cells can employ both power source charging and friction-charging concurrently. A coating method using such cells is described.

It is an object of the present invention to provide an apparatus, system and method for preparing uniformly coated prepreg substrates to be used in producing composites.

It is yet a further object of the invention to prepare prepregs with the coating penetrating more deeply into the substrate.

It is yet another object of the invention to form prepregs with resin loads smaller than those in prepregs prepared by other dry methods, particularly the electrostatic fluidized bed method.

It is yet another object of the invention to provide large-area coated substrates having uniform coatings, smaller resin loads and deeper coating penetration.

It is a further object of the present invention to more readily use micron-size resin particles in fabricating prepregs.

Other objects of the present invention will become apparent from the following embodiments of the present invention.

There is thus provided in accordance with the present invention an acceleration cell for coating a substrate with plastic resin particles which includes a housing having first and second ends, the first end containing an air inlet port and the second end an air outlet port. The housing further includes a particle feed port, which is formed in a wall of the housing between the inlet and outlet ports. The feed port is connected to a plastic resin particle source. The housing receives a carrier flow of air from the inlet port, which exits through the outlet port. The carrier flow takes up the resin particles delivered via the particle feed port, so that there is an outflow of the resin particles suspended in the carrier flow. The outlet port has a generally wide configuration with a width that is predetermined so as to correspond to the width of a substrate being coated. This allows the suspended resin particle outflow to deliver the resin particles across the entire width of the substrate. The acceleration cell also contains at least one electrostatic charger positioned in the housing which charges the particles suspended in the carrier flow. In addition, associated with the housing is at least one apparatus for accelerating the carrier flow and charged particles suspended in the flow through the housing. Additionally, the cell includes at least one flow-modifying apparatus disposed within the housing for modifying the suspended resin particle outflow so as to cause a uniform spatial distribution of the resin particles exiting from the cell, thereby producing a uniform spatial delivery of particles across the substrate.

In accordance with one embodiment of the present invention, the at least one flow-modifying apparatus is a turbulence-producing means. In some embodiments the turbulence-producing means is a plurality of deflectors; in other embodiments, the turbulence-producing means is a plurality of baffle-like elements producing sufficient turbulence to ensure the desired degree of uniformity in the spatial distribution of the exiting particles.

In further embodiments, the at least one flow-modifying apparatus is a plurality of airflow vanes. In some embodiments the length of these vanes is about 3 to 7 times the distance between adjacent vanes, while in other embodiments their length is about 4 to 6 times the distance between nearest neighbors.

In yet another embodiment, the length to height ratio (L/H) of the housing is between about 1 to about 10, where length L is the distance between the side of the at least one flow-modifying apparatus distal to the proximate side of a nozzle region of the housing, and the proximate side of the nozzle region. The height H is the distance between opposite surfaces of the housing in the region defining length L; the height H is taken along a direction generally parallel to the shorter side of the air outlet port. In another embodiment, the length to height (L/H) ratio is between 3 to 5.

Additionally, in another embodiment of the invention the at least one apparatus for accelerating the carrier flow and charged particles suspended in the flow is at least one sloped wall of the housing, the sloped wall narrowing the housing in the direction of the air outlet port. In some embodiments of the invention, the sloped wall of the housing has a slope that can range up to about 40 degrees, while in other embodiments the slope can range up to 15 degrees.

In a further embodiment of the invention, the slope of the at least one sloped wall is discontinuous as the wall proceeds in the direction of the air outlet port.

In yet another embodiment, the at least one apparatus for accelerating the carrier flow and charged particles suspended in the flow is a Venturi constriction, the Venturi constriction producing a pressure differential between the area in, and adjacent to, the constriction and the plastic resin particle source, thereby bringing the resin particles into the housing through the particle feed port.

Additionally, in an embodiment of the present invention, the at least one apparatus for accelerating the carrier flow and charged particles suspended in the flow is at least one electrically charged surface having a charge opposite to the charged particles.

In still another embodiment, the at least one apparatus for accelerating the carrier flow and charged particles suspended in the flow further includes a means for generating a magnetic field, the field increasing the uniformity of the spatial distribution of the particles exiting from the air outlet port.

In other embodiments the at least one apparatus for accelerating the carrier flow and charged particles suspended in the flow is a blower.

In a further embodiment of the invention, the air outlet port is a rectangular slot aperture characterized by at least one of the following: an aspect ratio ranging from about 1 to about 3000, and a length of at least 2 mm. In another embodiment of the invention, the air outlet port is a rectangular slot aperture characterized by at least one of the following: an aspect ratio ranging from about 1 to about 200, and a length of at least 50 mm.

In still another embodiment of the invention, the air outlet port is a conic section shaped aperture, where the aperture is characterized by at least one of the following: a major to minor axis ratio ranging from about 1 to about 3000, and a major axis of at least 2 mm. In another embodiment of the invention, the air outlet port is a conic section shaped aperture, where the aperture is characterized by at least one of the following: a major to minor axis ratio ranging from about 1 to about 200, and a major axis of at least 50 mm.

In yet another embodiment of the invention, the at least one electrostatic charger includes a high-voltage power source that applies voltage to at least one chargeable surface, the chargeable surface providing charge to the carrier flow of air in the housing, the charge then being transferred to the resin particles. In an embodiment of the invention, the at least one chargeable surface is at least one brush. In yet another embodiment of the invention, the at least one charger is at least one friction-charging surface.

Additionally, in another embodiment of the invention, at least one friction-charging surface includes at least one surface selected from the following list of surfaces: at least one planar surface, at least one undulating surface, at least one roughened surface, and at least one smooth surface.

In a further embodiment of the invention, the cell includes both at least one friction-charging surface and at least one high-voltage power source that applies voltage to at least one chargeable surface, the chargeable surface providing charge to the carrier flow of air in the housing, which is then transferred to the resin particles. In some embodiments these components can be used in series and in others in parallel.

Additionally, in an embodiment of the invention, the second end of the housing is a detachable sleeve with the sleeve being replaceable with another sleeve having an air outlet port of a different size. In other embodiments, the second end of the housing is a sleeve with an air outlet port, the size of the outlet port being variable.

In an embodiment of the invention, the cell further includes a humidity controller.

Additionally, in yet another embodiment of the invention, the average velocity of the particles is at least 0.1 m/s as they exit the air outlet port of the cell, while in still another embodiment, the average velocity of the particles is at least 0.5 m/s as they exit the air outlet port of the cell.

Additionally, there is provided in accordance with the present invention a system for coating a substrate with plastic resin particles, the system including a coating chamber and at least one acceleration cell constructed according to any one of the previous embodiments. The at least one cell jets charged resin particles at high velocities into the coating chamber through an air outlet port of the acceleration cell. The system also includes a substrate positioned in the coating chamber on which the jetted high-velocity charged resin particles are deposited. In addition, the system contains a heat source for melting the resin particles deposited on the substrate, whereby the melted resin coats the substrate.

In an embodiment of the present invention, the substrate positioned in the chamber is moving.

In a further embodiment of the present invention, the average velocity of the jetted particles as they exit the air outlet ports is at least 0.1 m/s. In other embodiments, the velocity is at least 0.5 m/s.

Further, in accordance with another embodiment of the present invention, the at least one acceleration cell is at least two acceleration cells. In some embodiments, at least one of the at least two acceleration cells charges the particles by friction and at least one of the at least two acceleration cells charges the resin particles by using a high-voltage power source.

Additionally, in another embodiment of the present invention, the at least one acceleration cell charges the resin particles by friction.

In another embodiment of the present invention, the at least one acceleration cell charges the resin particles by using at least one high-voltage power source.

Further, in an embodiment of the present invention, the at least one acceleration cell includes both friction-charging components and high-voltage power source charging components, and the cell charges the resin particles by at least one of these methods. Additionally, in an embodiment of the invention, the frictional and high-voltage components are used in series, while in another embodiment they are used in parallel.

In still another embodiment of the present invention, the substrate is charged so as to attract the jetted charged particles entering the coating chamber from the at least one acceleration cell, thereby further accelerating the particles. In some embodiments, the substrate is charged by moving it past at least one contacting plastic body, while in others it is charged by a power source.

In a further embodiment of the present invention, the coating chamber further includes at least one charged element positioned substantially opposite the air outlet port of the at least one acceleration cell so as to attract and accelerate the jetted charged particles emitted from the acceleration cell.

In still another embodiment of the present invention, the system further includes a computerized control system for control of the active elements which regulate at least one of the following parameters: charging voltage, speed of conveyance of the substrate, speed of the carrier flow in the acceleration cells, size of the air outlet port, quantity of resin particles brought into the cell, output voltage and output current. The control system is in communication with sensors in the system, the sensors sensing the values of at least one of the above parameters. Based on the sensed values, the computer adjusts the values of the parameters by communicating the optimizing values to the active elements.

In yet another embodiment, the system further includes a humidity controller.

In a further embodiment, the orientation of the at least one acceleration cell is such that the particles emitted from the air outlet port of the cell impinge the substrate substantially perpendicularly.

In still another embodiment of the present invention, the orientation of the at least one acceleration cell is such that the particles emitted from the air outlet port of the cell impinge the substrate at a generally non-perpendicular angle.

Further, in accordance with the present invention, a plane containing the air outlet port of the acceleration cell makes an angle of between about 60 and about −60 degrees with respect to the normal to a plane of the substrate, the plane of the substrate being the plane being coated.

Additionally, there is provided in accordance with the present invention a method for coating a large-area substrate where the method includes the steps of:

positioning the substrate in a coating chamber;

accelerating charged resin particles through an air outlet port of at least one acceleration cell, the acceleration cell being constructed as described above, the particles impinging and depositing on a wide swath of the substrate, the particles moving with a velocity of at least 0.1 m/s as they exit the air outlet port; and

melting the deposited resin particles, thereby coating the substrate.

In another embodiment of the invention, the positioning step of the method includes moving the substrate through the chamber.

Further, in accordance with another embodiment of the present invention, during the accelerating step of the method, the particles coat continuous wide swaths of a continuously moving substrate.

In still another embodiment of the invention, the method also includes the step of attracting the charged particles toward the substrate.

In yet another embodiment of the method of the present invention, the method includes a second accelerating step where the first accelerating step accelerates particles having diameters equal to or less than a predetermined diameter, while the second accelerating step accelerates particles having diameters greater than the predetermined diameter. In some embodiments, this predetermined diameter is 5 microns.

In a further embodiment of the invention, the positioning step of the method includes positioning a web-like substrate that is moving through the coating chamber.

In another embodiment of the invention, the particles exit the air outlet port with a velocity of at least 0.5 m/s.

### BRIEF DESCRIPTION OF THE DRAWINGS

The present invention will be understood and appreciated more fully from the following detailed description taken in conjunction with the drawings in which:

FIG. 1 is a schematic cross-sectional view of a typical prior art fluidized bed coating apparatus;

FIG. 2 is a schematic side view illustration of a coating line incorporating a coating apparatus and system constructed in accordance with a preferred embodiment of the present invention;

FIG. 3 is a side view illustration of a coating chamber constructed and operative according to an embodiment of the present invention;

FIGS. 4A and 4B are isometric views of a high-voltage charging acceleration cell and coating chamber constructed in accordance with a preferred embodiment of the present invention;

FIGS. 5A and 5B are schematic side and top views, respectively, of an acceleration cell using high-voltage to charge resin powder, constructed in accordance with a preferred embodiment of the present invention;

FIGS. 6A and 6B are schematic side and top views, respectively, of an acceleration cell using friction to charge resin powder, constructed according in accordance with a preferred embodiment of the present invention;

FIGS. 7A-7C are respectively top-side, top and side schematic views of a nozzle suitable for use in acceleration cells constructed according to embodiments of the present invention;

FIG. 8 is a schematic cut-away, top-side view of a portion of an acceleration cell constructed in accordance with a preferred embodiment of the present invention; and

FIGS. 9A, 9B and 9C are top-side and top views, respectively, of turbulence-producing elements for use with the embodiment shown in FIG. 8.

Similar elements in the Figures are numbered with similar reference numerals.

### DETAILED DESCRIPTION OF PREFERRED EMBODIMENTS

Prepregs currently used to form composite materials are often characterized by very non-uniform plastic resin coatings, high resin loads and little penetration of the substrate by the resin. Applicant has realized that the use of high-velocity (“forced flow”) charged resin particles ejected from an acceleration cell that electrostatically charges such particles can obviate these problems. Applicant has developed a cell for coating wide area substrates where the cell has a uniformly charged resin particle discharge stream. The particles constituting the discharge stream are traveling at relatively high velocities compared to prior art dry coating systems. Uniformity and velocity are maintained by means which include, but are not limited to, blowers, Venturi constrictions, turbulence-producing baffles, air control vanes, and a decreasing internal cross-sectional area of the cell in the direction of the cell's wide aperture. The acceleration cells discussed hereinbelow can employ, separately or concurrently, either high-voltage power source electrical charging or friction-charging methods. The acceleration cells can be used in coating systems described herein; a method for using these cells and systems for coating large-area, continuously moving substrates, is also described. The system is particularly useful for use with small micron-size resin particles, the fabrication of which has recently been improved, and for which increased future usage is expected.

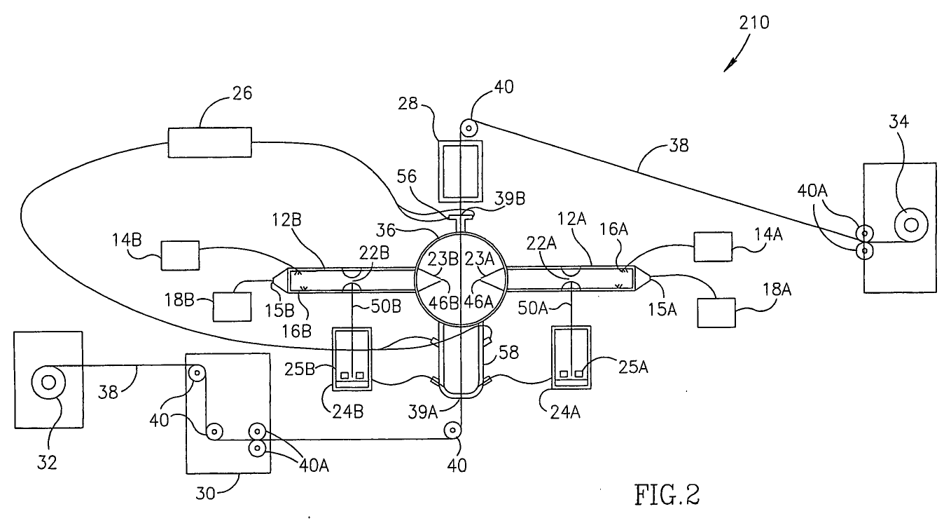

Reference is now made to FIG. 2 in which is illustrated a schematic view of a typical coating line, referenced generally 210, incorporating a coating apparatus and system constructed and operative in accordance with a preferred embodiment of the present invention. A substrate referenced 38 is led from a pay-off roller 32 to a take-up roller 34. Optionally, the substrate can be passed through a wetting station 30, which moistens substrate 38, improving the subsequent attachment of charged powder to substrate 38. Wet station 30 will most beneficially be used when substrate 38 is an aramide or glass substrate. The substrate is then passed through a coating chamber 36 and a heating means 28. Substrate 38, typically a carbon, glass, or aramide substrate such as Kevlar®, is guided along line 210 by a plurality of control rollers 40, some of which are nip rollers 40A. Nip rollers 40A also assist in controlling the speed of substrate 38 as it traverses coating line 210.

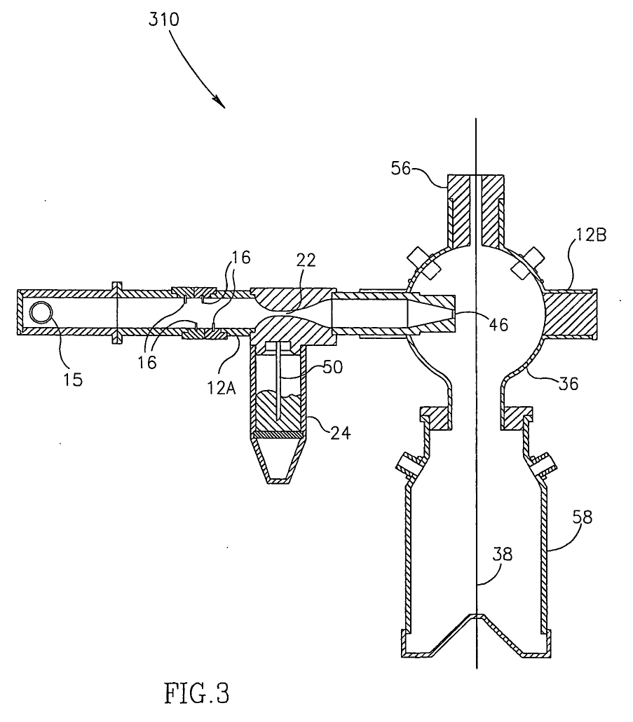

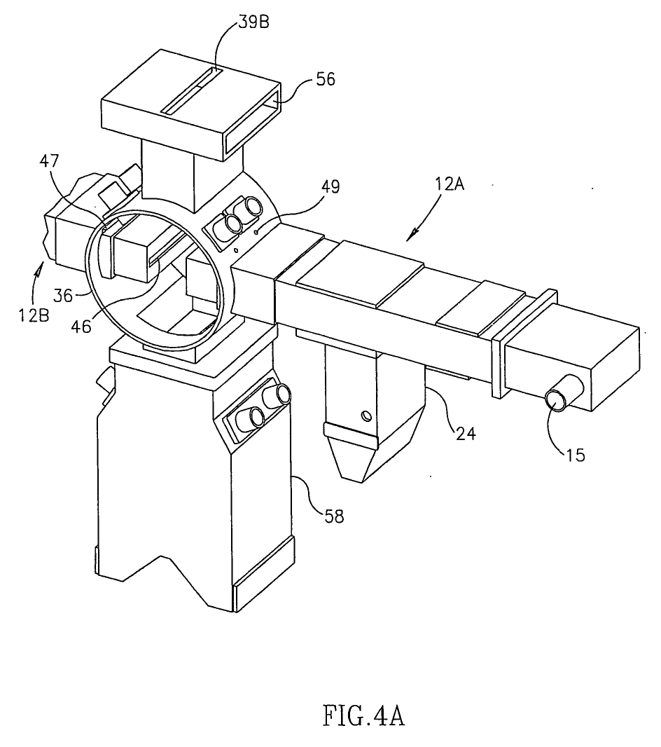

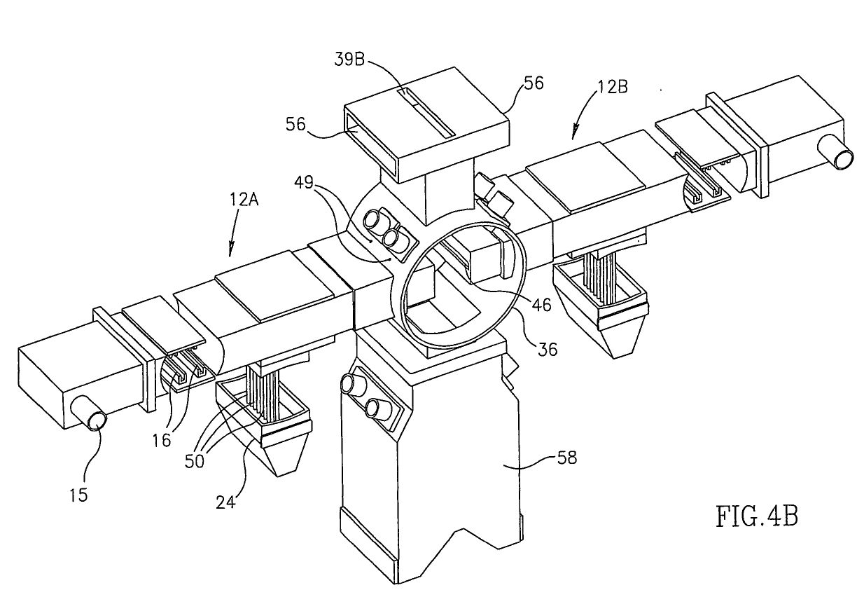

Two electrostatic acceleration cells 12A and 12B, having wide apertures 46A and 46B respectively, are positioned substantially opposite each other in coating chamber 36. Acceleration cells 12A and 12B charge resin powder particles brought into the cell as described below. While not readily seen in FIG. 2, acceleration cells 12A and 12B protrude into chamber 36; this can be better seen in FIGS. 3, 4A and 4B discussed hereinbelow. The charged powder exiting from acceleration cells 12A and 12B at apertures 46A and 46B, enters coating chamber 36, impinges on moving substrate 38 at high velocities, and adheres electrostatically to substrate 38.

In FIG. 2, apertures 46A and 46B of acceleration cells 12A and 12B are shown to be substantially co-linear with each other and perpendicular to the path of the substrate. In other embodiments, while the main portion of each of acceleration cells 12A and 12B may be independently oriented perpendicularly to the path of the substrate, nozzles 23A and 23B of cells 12A and 12B can be angularly displaced with respect thereto. Preferably, however, nozzles 23A and 23B are oriented so as to project particles perpendicularly to the path of the substrate.

In FIG. 2, wide aperture acceleration cells 12A and 12B use high-voltage supplied by DC power supplies 14A and 14B to charge a preselected resin powder stored at powder storage boxes 24A and 24B. Powdered resin 25A and 25B is brought into cells 12A and 12B through powder tubes 50A and 50B from powder boxes 24A and 24B at Venturi constrictions 22A and 22B formed in respective cells 12A and 12B. As air is accelerated in cells 12A and 12B, as by use of a pair of air blowers 18A and 18B, past Venturi constrictions 22A and 22B, a drop in pressure is produced at constrictions 22A and 22B. This decrease in pressure causes a pressure differential to exist between constrictions 22A and 22B and the interior of powder boxes 24A and 24B, thereby drawing powder up into cells 12A and 12B.

Blowers 18A and 18B blow dry air into cells 12A and 12B via inlets, respectively referenced 15A and 15B, past brushes, respectively referenced 16A and 16B, mounted within cells 12A and 12B, as shown. Brushes 16A and 16B, typically made of brass or iron, are connected to high-voltage DC power supplies 14A and 14B. Brushes 16A and 16B facilitate the charging of the moving air, which in turn transfers charge to the powdered resin. The charged air and resin particles are accelerated toward coating chamber 36 as they pass through Venturi constrictions 22A and 22B. Between Venturi constrictions 22A and 22B and apertures 46A and 46B, at least part of the charged air transfers charge to the powdered resin. While the air-moving means driving air through inlets 15A and 15B have been exemplified as air blowers, other suitable means could also be used, in accordance with alternative embodiments of the present invention.

Coating chamber 36 is typically a plastic cylindrical chamber, into which acceleration cells 12A and 12B protrude, and has formed therewith a powder basin 58 into which unattached resin powder falls. The powder collected in powder basin 58 may then be returned via intermediate powder storage boxes (not shown) and a filtration device (also not shown) to powder boxes 24A and 24B from which it is again drawn into acceleration cells 12A and 12B.

Coating chamber 36 is also formed with ports 39A and 39B through which substrate 38 enters and exits coating chamber 36. Near exit port 39B there is a vacuum port 56 connected to vacuum powder collector 26 that collects the loose, excess powder in chamber 36. The vacuum can be used to fine tune the resin load on substrate 38, as by thinning out the resin particle layer on substrate 38 by removing poorly attached resin powder from substrate 38 as substrate 38 exits chamber 36.

Substrate 38, covered with electrostatically attached powdered resin, then advances to heating means 28 where the resin is melted, allowing the resin to flow over substrate 38. Typically, but without being limiting, heating means 28 can be any of the large number of commercially available hot air or IR ovens. Substrate 38 is then led to take-up roller 34 via a pair of nip rollers 40A.

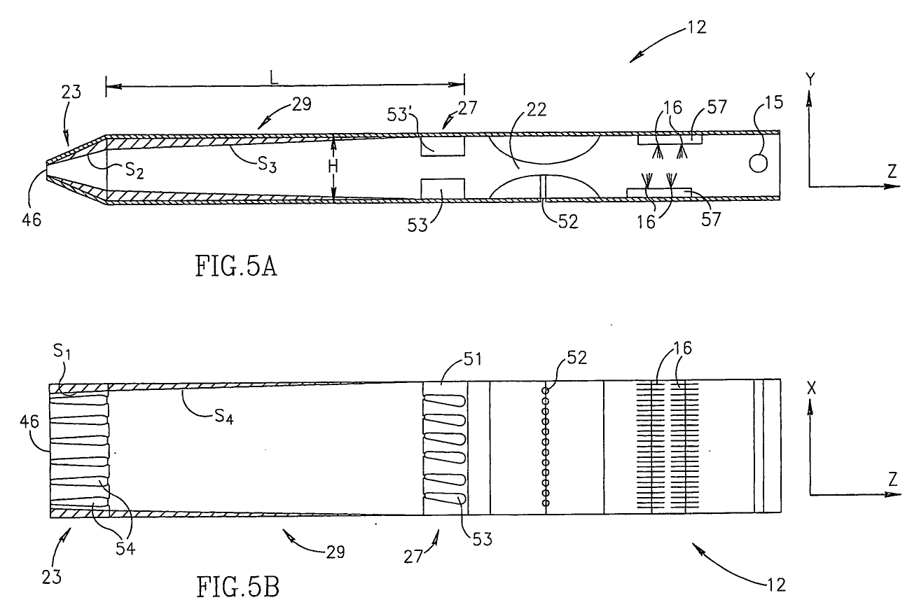

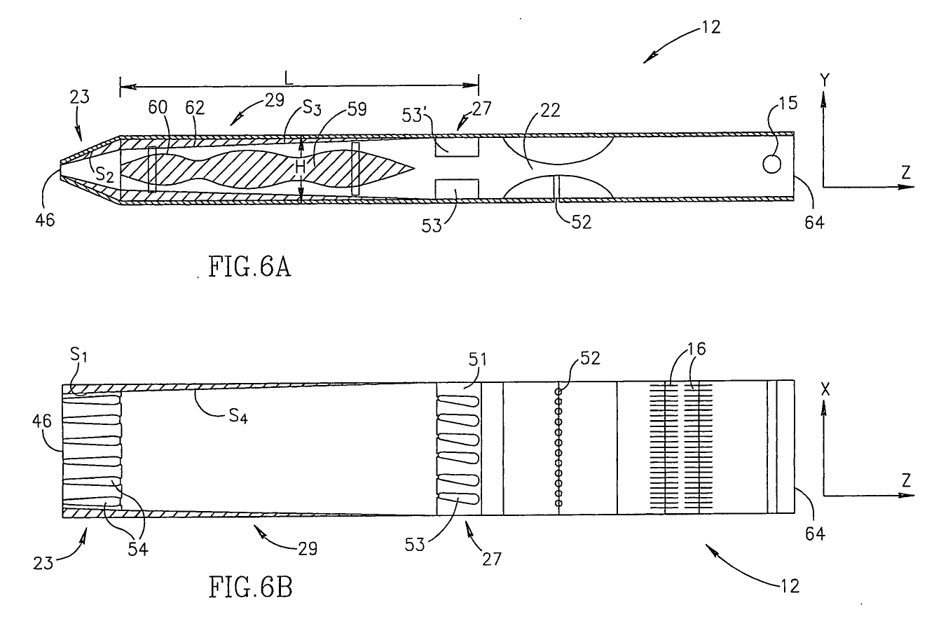

Acceleration cells 12A and 12B employ high-voltage DC power supplies 14A and 14B to charge the resin particles. The cells and their operation are described in more detail in conjunction with FIGS. 5A and 5B below. In other embodiments, acceleration cells employing friction-charging means can be used to charge the resin powder. Such cells are similar to the ones described above and are described in more detail in conjunction with FIGS. 6A and 6B below.

Referring now to FIGS. 3, 4A and 4B, there is seen a coating apparatus 310, constructed in accordance with a preferred embodiment of the present invention. The illustrated components are similar to those shown and described above in conjunction with FIG. 2. Similar components are therefore referenced by similar numerals, and are not specifically described again except as may be necessary to gain a further understanding of the present embodiment. Acceleration cell 12A uses a high-voltage DC power source (not shown) to charge resin powder. The cell has a wide aperture 46 through which powder is projected into coating chamber 36. While shown in FIGS. 3 and 4A, second acceleration cell 12B is truncated and not presented in a cut-away view. Powder basin 58 catches powder that enters chamber 36 but which fails to attach to the substrate. A vacuum apparatus (not shown) removes all resin powder that does not adhere tightly to substrate 38 and that is found loose within chamber 36 through vacuum port 56.

Referring now to FIGS. 5A and 5B, there is shown, in schematic form, the acceleration cell 12 as shown and described above in conjunction with the embodiment of FIGS. 2-4B, in accordance with a preferred embodiment of the invention. Acceleration cell 12 charges dry air using a high-voltage DC power source (not shown). Cell 12 includes brushes 16 attached to leads 57; the brushes increase the efficiency of charging the air as it is forcibly blown through cell 12 by a blower (not shown). The dry ionized air blown through cell 12 flows through Venturi constriction 22 where it is accelerated toward aperture 46.

Powder is introduced into cell 12, substantially as described above in conjunction with FIGS. 2, 3, 4A and 4B, from a powder box 24 (FIGS. 2 and 3) through powder tube 50 (FIGS. 2 and 3) via powder feed ports, referenced 52, formed proximate to Venturi constriction 22. Powder feed ports 52 are most clearly seen in FIG. 5B.

After entering cell 12, the resin powder acquires electrostatic charge from the ionized air, the latter also serving as a carrier medium for the charged powdered resin. A series of airflow control vanes 54, most clearly seen in FIG. 5B, is located in the forward part of cell 12 that lies between the Venturi constriction 22 and aperture 46. Typically, but not necessarily, the vanes are positioned in the nozzle portion 23 of cell 12. Vanes 54 are important to assure a uniform discharge stream of particles as the particles exit cell 12 and enter coating chamber 36. In order to improve uniformity, the length of the vanes is typically 3 to 7 times the distance between adjacent vanes, preferably 4 to 6 times the distance between nearest neighbor vanes.

Another embodiment of an acceleration cell includes several smaller vanes (not shown) formed between vanes 54, shown in FIG. 5B, in a region close to aperture 46. In yet other embodiments, vanes 54 extend from nozzle portion 23 in the direction of Venturi constriction 22, reaching mixing region 27 discussed below.

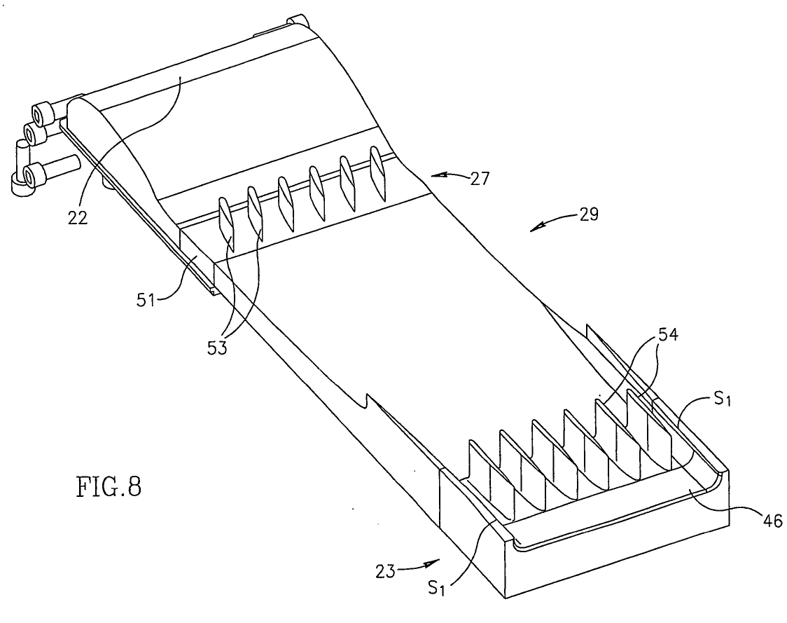

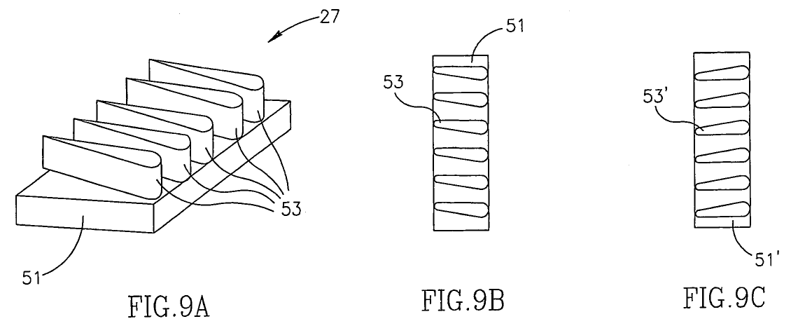

As seen in FIGS. 5A and 5B, a plurality of deflectors 53 is formed on a base portion 51, thereby to define within cell 12 a mixing region, referenced generally 27. The provision of the deflectors 53 gives rise to turbulent flow, thereby to improve the uniformity of the spatial distribution of the particles. These deflectors are shown and described in greater detail below with reference to FIGS. 8, 9A and 9B. While deflectors have been described as the turbulence-producing means above, any baffle-like elements, or other turbulence-generating means disposed in any manner could also be used, provided the desired degree of uniformity is attained. More generally, any means can be used that produces a uniform distribution of particles in the discharge stream exiting from the cell through its wide aperture.

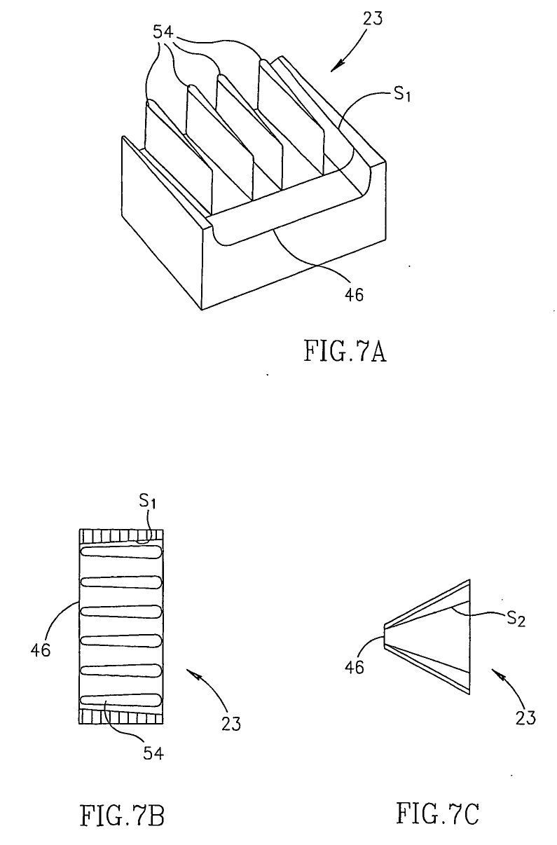

Acceleration cells 12, as depicted in FIGS. 5A and 5B, show the interior walls of a stabilization region 29 to be formed as a first sloped portion S3, and a second, more sharply sloped portion S2 contiguous therewith, formed within nozzle 23, proximate to aperture 46. These sloped portions are described hereinbelow with reference to FIGS. 7A-7C, 8, 9A and 9B.

As described above, Venturi constriction 22 is provided so as to generate a pressure reduction in the region of the constriction that allows for the introduction of resin powder into acceleration cell 12, accelerating the powder therein. It will be appreciated that the Venturi constriction 22 can be located at any position along the length of acceleration cell 12 between brushes 16 and mixing region 27. Furthermore, it will be readily apparent to one skilled in the art that other methods for introducing the resin into the cell are also possible. Examples of such other methods include the placement of powder in a powder box above acceleration cell 12, the powder box being shaken so as to cause a gravity feed into the cell. Additionally, any vacuum-producing device attached to the powder box could be used to draw powder into the cell.

Since ensuring coating uniformity is critical, acceleration cell 12 of FIGS. 5A and 5B is typically constructed so that the length (L) of the cell from the beginning of the mixing region to the beginning of the nozzle region is 1-10 times, and preferably 3-5 times, the height (H) of the cell. For purposes of this ratio, the height of the cell is defined as the distance along the y-axis as shown in FIGS. 5A and 5B in the region defined by L above. Similarly, uniformity typically requires an aspect ratio of wide aperture 46 of 1-3000, and preferably 1-200. The aspect ratio is herein defined as the ratio of the aperture's longer dimension to its shorter dimension e.g. length to width or major to minor axes. Typically, the aperture's longest dimension, its length, can range from at least 2 mm, preferably from at least 50 mm, to 1.8 meters, or even more.

While slot-like apertures, i.e. rectangular apertures, are generally used and have been described in the embodiments above, elliptical apertures of suitable dimensions can also be used. Similarly, circular apertures of wide enough radii can be employed. Apertures having tooth-shaped baffles positioned across their face can also be used.

Referring now to FIGS. 6A and 6B, there is shown, in schematic form, the acceleration cell 12 as shown and described above in conjunction with the embodiment of FIGS. 3-4B, in accordance with an alternative preferred embodiment of the invention, and in which resin powder is charged by friction. Arranged within cell 12 is a wave plate 59, typically constructed from a plastic material like Teflon or nylon, which has an undulating surface 60. Air is blown by a blower (not shown) from an opening 15 in end 64 of acceleration cell 12 past a Venturi constriction 22, so as to cause a drop in pressure, generally as described above in conjunction with FIG. 2, thereby to cause resin powder to be drawn from a powder box 24 (FIG. 2) through tube 50 (FIG. 2) into cell 12. The powder transported by the moving air moves past the undulating surface 60 of wave plate 59, where the powder is charged by friction. The powder is then expelled through aperture 46 into coating chamber 36, the latter best seen in FIGS. 2-4B. The likelihood of clogging in cell 12 is reduced because undulating surface 60 is spaced far enough away from the inside surface of housing 62. Additionally, clogging is mitigated and the charged particle distribution made more uniform because undulating surface 60 provides for non-streamline flow.

Typically, the inside surface of housing 62 is formed having a textured surface, while the surface 60 of wave plate 59 is made to be generally smooth. Both housing 62 and wave plate 59 are generally fabricated from plastic. The inside surface of housing 62, or the housing 62 itself, and wave plate 59 can be made from the same or different plastics. The nature of the plastics employed determines whether the charge on the resin powder will be positive or negative. Typical plastics that can be used are Teflon®, nylon, propylene, and acrylics. The aforementioned list is exemplary only and not intended to be limiting. It is readily apparent to one skilled in the art that the speed of the particles across the friction-charging surfaces 60 and 62 is an important factor in determining the efficacy of charging.

As in the embodiment of FIGS. 5A and 5B, the present embodiment also has a mixing region 27 having deflectors 53 positioned on a base 51. Their construction and function are similar to deflectors 53 in mixing region 27 described with FIGS. 5A and 5B and discussed in greater detail with FIGS. 8, 9A and 9B below. In addition, also as described in FIGS. 5A and 5B, FIG. 6A shows a slope S3 in stabilization region 29 and an even sharper slope S2 in nozzle 23 near aperture 46. These slopes will be discussed further with reference to FIGS. 7A-7C, 8 and 9A and 9B.

As is apparent from the descriptions of the embodiments associated with FIGS. 5A, 5B, 6A and 6B, the present invention uses a high-pressure, high-velocity stream (“forced flow”) of charged resin powder. This “forced flow” stream ensures greater coating uniformity and penetration of the substrate than is possible with low pressure, low-velocity charged resin clouds, such as those used in prior art fluidized bed coaters. Furthermore, the acceleration cells of the present invention have typically long, narrow apertures, which can continuously coat large moving swaths of substrate. Other high-velocity coating devices generally use small diameter circular apertures with narrow beam widths, making uniform coating of large-area substrates difficult. Penetration into the substrate is also improved because the acceleration cells constructed according to the present invention can employ micron-size particles. The velocity of the charged particles as they exit the wide aperture of the acceleration cell is at least 0.1 m/s, preferably between about 1 to about 10 m/s. The maximum velocity will generally be that velocity that begins to cause deterioration in the substrate.

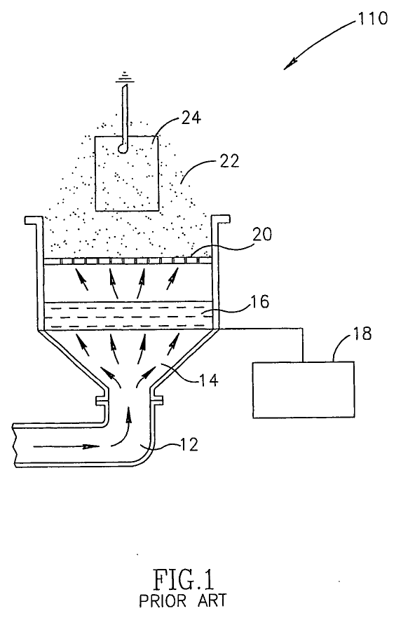

Electrostatic fluidized bed (EFB) coaters, such as the one shown in FIG. 1, employ particles that have low velocities. Clouds of such particles have a layered distribution. Heavier particles tend to settle and make up a greater percentage of the lower layers of an EFB particle cloud, while smaller particles make up a greater portion of the upper strata. As a result, it is readily apparent that when a substrate moves perpendicularly to the airflow in an EFB coater, the coating can never be entirely uniform. This situation does not occur with embodiments of the present invention.

While in the embodiments of the system shown in FIGS. 2, 3, 4A and 4B two acceleration cells are used as described in FIGS. 5A-6B, three or more cells may also be used in accordance with further embodiments of the invention.

Typically, both cells of the embodiments discussed with FIGS. 2-4B are of the same type, either frictional or electrical charging cells. However in other embodiments, the coating systems described herein employ at least one friction-charging cell and at least one electrical charging cell, concurrently.

In yet other embodiments, the mechanisms for both types of charging can be positioned in a single cell housing and the two types of mechanisms can be used in parallel or serially. Typically, but without being limiting, when used in parallel, each of the two different charging mechanisms can be positioned side by side, parallel to the long axis of the cell.

When used in series, the portion of the cell on the side of the Venturi constriction distal from the wide aperture is typically constructed as shown in FIGS. 5A and 5B with a brush element connected to a DC power source. The portion of the cell between the Venturi constriction and the wide aperture is constructed as in FIGS. 6A and 6B with a wave plate. Powder brought into the cell is thus first charged by ionized air previously charged by the brushes; the powder then undergoes charging by friction at the wave plate.

In yet another embodiment, the two mechanisms can be used serially with the resin particles first charged by friction and then by electrically charged brushes. In such an embodiment, both the frictional wave plate and the charged brushes are typically placed between the Venturi constriction and the wide aperture of the cell. In this last embodiment, the brushes generally lie closer to the wide aperture and the wave plate closer to the Venturi constriction. It should be understood that the configurations in the embodiments describing serial and parallel usage hereinabove is exemplary only and not intended to be limiting.

The capability of using both methods of charging concurrently, as described in the preceding embodiments, is particularly advantageous. The ability of certain plastic resins to be charged by friction is more limited than others. Using high-voltage charging would obviate the difficulty. On the other hand some plastics are relatively easily charged by friction and high-voltage charging would be unnecessary. Additionally, small micron-size particles are more easily charged by friction than larger particles. The use of micron-size resin particles will become more prevalent because of recent improvements in their manufacture. If a resin with a wide particle size distribution is used, the capability of charging by both methods simultaneously, as described in the last embodiments, will make charging, and the entire coating system, more efficient.

Since high particle velocity is important to ensure coating uniformity and particle penetration of the substrate, various means can be used to increase the velocity of the charged resin particles. Some of these means can be positioned in the acceleration cell, while others can be added to the coating system.

Charging the substrate with a polarity opposite to that of the impinging charged resin particles can increase velocity. The substrate can be charged by contacting it with a plastic body, such as a plastic plate or plastic roller, as the substrate moves through the coating chamber. Alternatively, the substrate can be charged directly using a high-voltage power supply.

Another means to increase particle velocity is best illustrated in the embodiment shown in FIG. 4A. Particle velocity can be enhanced by placing a conductive metal strip 47 in coating chamber 36, substantially opposite wide aperture 46 of acceleration cell 12. Strip 47 is charged oppositely to that of the resin particles via contacts 49 located on the outside of chamber 36. Accordingly, strip 47 attracts and accelerates the particles toward the intervening substrate (not shown).

Electrostatically charged plates, sometimes used in conjunction with magnetic fields, can be appropriately positioned within the acceleration cells or within the coating chamber to increase particle velocity. In addition to accelerating the particles, such plates and fields can be used to manipulate the particle beam, making it more uniform.

Velocity enhancement can also be effected in the acceleration cells by using sloped walls inside the cells. This has been mentioned previously in the discussion of FIGS. 5A-6B and will be expanded upon below in a discussion of FIGS. 7A-9B.

Yet another method for increasing the velocity of the charged resin particles includes altering the geometry of the Venturi constriction, particularly its slope on the wide aperture side of the constriction. Increasing the size of the powder inlets near the Venturi constriction, or using inlets of different sizes, also can increase the velocity of the charged particles.

Reference is now made to FIGS. 7A-7C where three schematic views of a nozzle 23 of an acceleration cell 12 are shown. Nozzle 23 represents the end of an acceleration cell closest to the coating chamber. Nozzle 23 shown in FIGS. 7A-7C can be used with both the high-voltage and friction-charging type acceleration cells discussed above. The nozzle shown enhances particle beam uniformity and increases the velocity of the particles.

A top-side schematic cut-away view of nozzle 23 of an acceleration cell constructed and operative according to the present invention is shown in FIG. 7A. Nozzle 23 contains four airflow control vanes 54, which assist in controlling the spatial uniformity of the particle distribution. It is readily understood that more or less than four vanes can also be present. Vanes 54 can be constructed of any suitable plastic.

In the embodiment of the present invention shown in FIGS. 7A-7C, nozzle 23 is constructed so that there are slopes (S1 and S2) in two dimensions of the nozzle. This can best be seen in FIGS. 7B and 7C which are schematic top and side views respectively of nozzle 23. In yet other embodiments, a slope can be present in only a single dimension, such as the one shown in FIG. 7C, with a slope absent from the dimension best seen in FIG. 7B. In still other embodiments, shown in FIGS. 5A-6B, in addition to slopes S1 and S2 of nozzle 23, acceleration cell 12 also contains slopes S3 and S4 extending back into the acceleration cell, almost reaching Venturi constriction 22 or mixing region 27, the latter to be discussed below.

The slope of acceleration cell 12 from wide aperture 46 to mixing region 27 or Venturi constriction 22 does not need to be a constant. As best illustrated in FIGS. 5A and 6A, the slope can be less in the stabilization region 29 extending from the mixing region 27 to nozzle 23 and greater in the region of nozzle 23. Including a slope in the part of acceleration cell 12 closest to aperture 46 increases the uniformity of the charged particle distribution and accelerates the particles as they approach and exit aperture 46. Typically, the angle of slopes S1 and S2 in the region of nozzle 23 can range up to about 40 degrees, preferably up to about 15 degrees and even more preferably up to 10 degrees.

In the above discussion and Figures, we have used S1-S4 as the four possible slopes of the various regions of the acceleration cell. The use of different designations 1-4 for the four slopes does not necessarily imply that they are all different. In some embodiments, some, or all, of the slopes may be identical.

Reference is now made to FIG. 8 where a cut-away, top-side view of the region between the Venturi constriction 22 and the wide aperture 46 of a typical acceleration cell, constructed and operative according to a preferred embodiment of the present invention, is shown. This part of the cell includes several regions: a Venturi constriction 22, a mixing region 27, a stabilization region 29 and a nozzle region 23. Nozzle region 23 has been discussed above with respect to FIGS. 7A, 7B and 7C. Similarly, the Venturi constriction 22 has been discussed elsewhere. Mixing region 27 is meant to increase the uniformity of the charged particle distribution, while stabilization region 29 is intended to stabilize the flow as the particles approach nozzle region 23 where they are further accelerated by an increasingly sloped internal wall and a constantly decreasing cross-sectional area.

Mixing region 27 can be constructed as shown in FIGS. 9A, 9B and 9C to which reference is now made. In the embodiment shown, deflectors 53 introduce turbulence into the moving air and charged particles after they have traversed the Venturi constriction. This turbulence increases the uniformity of the particle distribution as the particles approach the nozzle region. As shown in FIGS. 9B and 9C, the orientation of deflectors 53, attached to the bottom of the cell, are typically opposite to that of deflectors 531, positioned on top of the cell. FIGS. 9B and 9C show top views of turbulence-inducing deflectors 53 and 53′, and their opposing displacements are clearly observable. In FIGS. 9A, 9B and 9C, deflectors 53 and 53′ are mounted on bases 51 and 51′ respectively.

It should be readily apparent to those skilled in the art that the number of deflectors can be more or less than that shown in the figures, the number being determined by the degree of agitation required for charged particle uniformity. It should further be apparent to one skilled in the art that turbulence-inducing elements of any shape, or the use of any turbulence-producing means, can be used as long as they produce a satisfactorily uniform particle distribution in the particle discharge stream. Moreover, any means—turbulence-producing or otherwise—that produces satisfactory uniformity in the particle distribution of the discharge stream can be used. One such means for improving uniformity would be the insertion of a plastic screen in the nozzle region of the acceleration cell. The screen would include a mesh large enough to prevent clogging and small enough to improve discharge stream uniformity.

In embodiments of the present invention, the size of the aperture, that is its length and width, and the angle at which the projected charged powder impinges on the substrate, can be adjusted to produce a powder coating of a desired thickness and uniformity. Therefore, further embodiments of the present invention provide for acceleration cells in which the apertures are mechanically variable apertures. In these embodiments, the size of the aperture and/or the angle between the plane containing the wide aperture and a plane, or a “virtual” plane, of the substrate being coated can be varied. The “virtual” plane here refers to instances when the substrate is not necessarily planar; the plane then being coated is a “virtual” plane, which constitutes the surface being coated projected onto a plane.

Alternatively, the aperture region of the cell can be enclosed in a detachable structure, the structure being replaceable with any of a series of similar structures, each such structure having an aperture of different dimensions, angle of incidence and/or shape. Depending on coating needs, the shapes of these structures can include conical structures such as those in FIG. 5A-6B, straight structures such as in FIGS. 3-4B and even round or rectangular horn-shaped structures similar to those found on loudspeakers.

It is readily apparent that the uniformity of the coating depends on the uniformity of the particle beam emitted from the aperture. Preferably, the beam should be as narrow as possible when emerging from the cell. Accordingly, increasing the cell's aperture aspect ratio, that is the ratio of the aperture's length to width (or equivalently the ratio of its larger to its shorter dimension) and/or decreasing the aperture's cross-sectional area, typically enhances the uniformity of the particle discharge stream.

Particle size also affects coating uniformity. Small particles of five microns or less have a greater surface area to volume ratio than larger particles. This results in a larger electrical charge to volume ratio, which increases particle velocity and enhances particle penetration of the substrate, leading to a more uniform coating and smaller resin loads. The fibers in composite substrates generally have a thickness of 5 to 20 microns and the inter-fiber spacings of such substrates are generally even smaller. As a result, it is readily apparent that particles of less than 5 microns can penetrate the spaces between such fibers more easily than conventional 50-100 micron resin particles. In addition, small micron-size particles, because of their high kinetic energy, can separate the fibers of the substrate. Finally, in addition to the penetration capability of small particles, they also charge more easily because of their greater surface area to volume ratio; accordingly, charging voltage can be reduced. As has been mentioned previously, recent improvements in the fabrication of micron-size resin particles will make the use of such small particles more commonplace. Mixed electrical/friction-charging cells or the concurrent use of both frictional and electrical charging cells in a single system as discussed above, will assist in assimilating such particles in prepreg manufacture.

It should be appreciated that two-stage coating would be particularly advantageous when using small particles. The first stage of coating would employ small (5 microns or less) particles and would ensure good penetration of the substrate and thus better uniformity. In the second stage of coating, larger size resin particles would be deposited; this would lead to a faster overall deposition rate and reduce the time needed to coat a unit length of substrate.

As can readily be concluded from the discussion above, achieving a uniform coating requires control of many variables. This includes controlling the charging voltage, air blower speed, pressure differential at the Venturi constriction and the amount of powdered resin carried per unit volume of airflow. Additional factors, which enter into the quality and uniformity of the coating, are the type, weave, fiber diameter and conductivity of the substrate. Additionally, the speed at which the substrate moves, the amount of powder used, the size distribution and density of the powder, the sizing used on the substrate, and the degree of ionization in the region of the substrate are important. The latter factor depends on charging voltage, humidity in the region of charging and the amount of charge lost in transit. Theoretically, as many of the above factors as possible should be monitored and, when necessary, adjusted to obtain an optimal coating.

A computerized control system can be used with embodiments of the present invention. Variables such as air blower speed, substrate velocity, charging voltage, output voltage and output current can be measured by various sensors and transferred to a data acquisition unit, which is part of the computer used to control the coater system. The computer can include additional interface provisions for controlling the coater's active elements (high-voltage power source, air blowers, substrate conveyor, etc.). One typical interface architecture that could be used includes a general purpose interface bus (GPIB). At the direction of the computer, the output of the active elements can be adjusted via the interface to provide the charging voltage, air blower speed, substrate velocity, etc. that optimizes the coating.

Prior to any control system being fully operational, data is gathered about as many of the key variables discussed above as possible, and a regression analysis for optimizing the coating is performed. This analysis and data are stored in the computer and used to analyze the values sensed by the above-mentioned sensors. Based on a comparison of the computer's stored data, regression analysis and the sensed data, the computer communicates, via the interface, to the active elements of the system the values required to optimize the coating.

The definitions given above have been adhered to while discussing the construction and operation of the present invention. However, it should be readily apparent that the above-described invention can be applied to other substrates whenever a uniform, low load coating is required. These substrates need not necessarily be substrates used in forming prepregs for use in fabricating composites. Without being limiting, these substrates can include solid substrates such as metal, wood and Formica®, among others. Furthermore, the substrates defined hereinabove, which inter alia include carbon fibers, fabrics, tow and strands can also include tapes and tubes, particularly carbon tapes and tubes.

It will be appreciated by persons skilled in the art that the present invention is not limited by what has been particularly shown and described hereinabove. Rather the scope of the invention is defined by the claims that follow.

1. An acceleration cell for use in the coating of a substrate with plastic resin particles, said cell including:
a housing which has first and second ends having formed thereat an air inlet port and an air outlet port, respectively, and which further has a particle feed port which is arranged in association with a plastic resin particle source and is formed in a wall of said housing between said inlet and outlet ports, wherein said housing is arranged to receive a carrier flow of air therethrough between said inlet and outlet ports, for taking up resin particles delivered thereto via said particle feed port, so as to result in an outflow of the resin particles suspended in the carrier flow,
wherein said air outlet port has a generally wide configuration having a width which is predetermined so as to generally correspond to the width of a substrate to be coated, thereby to impart to the suspended resin particle outflow a configuration operative to deliver the resin particles across generally the entire width of the substrate;
at least one electrostatic charger positioned in said housing for charging the particles suspended in and carried by the carrier flow;
at least one apparatus for accelerating the carrier flow and the charged particles suspended therein through said housing, said accelerating apparatus in association with said housing; and
at least one flow-modifying apparatus disposed within said housing for modifying the suspended resin particle outflow so as to cause a generally uniform distribution of the resin particles therein, giving rise to a correspondingly uniform delivery of the particles across the substrate.

2. A cell according to claim 1 wherein said at least one apparatus for accelerating the carrier flow and the charged particles suspended therein is at least one sloped wall of said housing, said sloped wall narrowing said housing in the direction of said air outlet port.

3. A cell according to claim 2 wherein said sloped wall of said housing has a slope which can range up to about 40 degrees.

4. A cell according to claim 2 wherein said sloped wall of said housing has a slope which can range up to about 15 degrees.

5. A cell according to claim 2 wherein the slope of said at least one sloped wall is discontinuous as said wall proceeds in the direction of said air outlet port.

6. A cell according to claim 1 wherein said at least one apparatus for accelerating the carrier flow and the charged particles suspended therein is a Venturi constriction, said Venturi constriction producing a pressure differential between the area in and adjacent to said constriction and said plastic resin particle source, thereby bringing resin particles into said housing through said particle feed port.

7. A cell according to claim 1 wherein said at least one apparatus for accelerating the carrier flow and the charged particles suspended therein is at least one electrically charged surface having a charge opposite to the charged particles.

8. A cell according to claim 1 wherein said at least one apparatus for accelerating the carrier flow and the charged particles suspended therein further includes a means for generating a magnetic field, the field increasing the uniformity of the spatial distribution of the particles exiting from said air outlet port.

9. A cell according to claim 1 wherein said at least one apparatus for accelerating the carrier flow and the charged particles suspended therein is a blower.

10. A cell according to claim 1 wherein said at least one flow-modifying apparatus is a turbulence-producing means.

11. A cell according to claim 10 wherein said turbulence-producing means is a plurality of airflow deflectors.

12. A cell according to claim 10 wherein said turbulence-producing means is a plurality of baffle-like elements.

13. A cell according to claim 1 wherein said at least one flow-modifying apparatus is a plurality of airflow vanes.

14. A cell according to claim 13 wherein the length of said airflow vanes is about 3 to 7 times the distance between adjacent vanes.

15. A cell according to claim 13 wherein the length of said airflow vanes is about 4 to 6 times the distance between adjacent vanes.

16. A cell according to claim 1 wherein the length to height ratio (L/H) of said housing is between about 1 to about 10, where the length L of said housing is the distance between the side of said at least one flow-modifying apparatus distal to the proximate side of a nozzle region of said housing, and the proximate side of the nozzle region, and said height H is the distance between opposite surfaces of said housing in the region defining length L, where the height is taken along a direction generally parallel to the shorter side of said air outlet port.

17. A cell according to claim 1 wherein the length to height ratio (L/H) of said housing is between about 3 to about 5, where said length L of said housing is the distance between the side of said at least one flow-modifying apparatus distal to the proximate side of a nozzle region of said housing and the proximate side of the nozzle region, and said height H is the distance between opposite surfaces of said housing in the region defining length L, where the height is taken along a direction generally parallel to the shorter side of said air outlet port.

18. A cell according to claim 1 wherein said air outlet port is a rectangular slot aperture, said slot aperture characterized by at least one of the following:
i. an aspect ratio ranging from about 1 to about 3000; and
ii. a length of at least 2 mm.

19. A cell according to claim 18 wherein said air outlet port is a rectangular slot aperture, said slot aperture characterized by at least one of the following:
i. an aspect ratio ranging from about 1 to about 200; and
ii. a length of at least 50 mm.

20. A cell according to claim 1 wherein said air outlet port is a conic section shaped aperture, said aperture characterized by at least one of the following features:
i. a major to minor axis ratio of about 1 to about 3000; and
ii. a major axis of at least 2 mm.

21. A cell according to claim 20 wherein said air outlet port is a conic section shaped aperture, said aperture characterized by at least one of the following features:
i. a major to minor axis ratio of about 1 to about 200; and
ii. a major axis of at least 50 mm.

22. A cell according to claim 1 wherein said at least one electrostatic charger includes a high-voltage power source which applies voltage to at least one chargeable surface, said chargeable surface providing charge to the carrier flow of air, the charge then being transferred therefrom to the resin particles.

23. A cell according to claim 22 wherein said at least one chargeable surface is at least one brush.

24. A cell according to claim 1 wherein said at least one electrostatic charger is at least one friction-charging surface.

25. A cell according to claim 24 wherein said at least one friction-charging surface includes at least one surface selected from the following list of surfaces:
i. at least one planar surface;
ii. at least one undulating surface;
iii. at least one roughened surface; and
iv. at least one smooth surface.

26. A cell according to claim 1 wherein said cell includes both at least one friction-charging surface and at least one high-voltage power source which applies voltage to at least one chargeable surface, said chargeable surface providing charge to the carrier flow of air in said housing, the charge then being transferred to the resin particles.

27. A cell according to claim 26 wherein said at least one friction-charging surface and said at least one high-voltage power source are used in series.

28. A cell according to claim 26 wherein said at least one friction-charging surface and said at least one high-voltage power source are used in parallel.

29. A cell according to claim 1 wherein the average velocity of the particles as they exit said air outlet port of said cell is at least 0.1 m/s.

30. A cell according to claim 1 wherein the average velocity of the particles as they exit said air outlet port of said cell is at least 0.5 m/s.

31. A cell according to claim 1 wherein said second end of said housing is a detachable sleeve, said sleeve being replaceable with another sleeve having an air outlet port of a different size.

32. A cell according to claim 1 wherein said second end of said housing is a sleeve with an air outlet port, the size of said air outlet port in said sleeve being variable.

33. A cell according to claim 1 wherein said cell further includes a humidity controller.

34. A system for coating a substrate with plastic resin particles, said system including:
i. a coating chamber;
ii. at least one acceleration cell constructed according to claim 1, said at least one cell jetting charged resin particles at high velocities into said coating chamber through an air outlet port of said acceleration cell;
iii. a substrate positioned in said coating chamber on which the jetted high-velocity charged resin particles are deposited; and
iv. a heat source for melting the resin particles deposited on the substrate, whereby the melted resin coats the substrate.

35. A system according to claim 34 wherein said substrate positioned in said chamber is a moving substrate.

36. A system according to claim 34, wherein said at least one acceleration cell charges the resin particles by friction.

37. A system according to claim 34, wherein said at least one acceleration cell charges the resin particles by using at least one high-voltage power source.

38. A system according to claim 34, wherein said at least one acceleration cell includes both friction-charging components and high-voltage power source charging components, said cell charging the resin particles by at least one of these methods.

39. A system according to claim 38 wherein said frictional and high-voltage charging components are used in series.

40. A system according to claim 38 wherein said frictional and high-voltage charging components are used in parallel.

41. A system according to claim 34 wherein said at least one acceleration cell is at least two acceleration cells.

42. A system according to claim 41 wherein at least one of said at least two acceleration cells charges the particles by friction and at least one of said at least two acceleration cells charges the resin particles by using a high-voltage power source.

43. A system according to claim 34, wherein said substrate is charged so as to attract the jetted charged particles entering said coating chamber from said at least one acceleration cell, thereby further accelerating the particles.

44. A system according to claim 43 wherein said substrate is charged by moving it past at least one contacting plastic body.

45. A system according to claim 43 wherein said substrate is charged by a power source.

46. A system according to claim 34 wherein said coating chamber further includes at least one charged element positioned substantially opposite said air outlet port of said at least one acceleration cell so as to attract and accelerate the jetted charged particles emitted from said acceleration cell.

47. A system according to claim 34 further comprising a computerized control system for control of active elements of said system, said control system regulating at least one of the following parameters:
i. charging voltage;
ii. speed of conveyance of said substrate;
iii. speed of carrier flow in said acceleration cells;
iv. size of said air outlet port;
v. quantity of particles brought into said cell;
vi. output voltage; and
vii. output current,
said control system in communication with sensors in said system, said sensors sensing the values of at least one of the above parameters and, based on the sensed values, a computer of said control system adjusting the values of at least one of the above parameters by communicating optimizing values to said active elements.

48. A system according to claim 34 wherein said system further includes a humidity controller.

49. A system according to claim 34 wherein the orientation of said at least one acceleration cell is such that the particles emitted from said air outlet port of said cell impinge said substrate substantially perpendicularly.

50. A system according to claim 34 wherein the orientation of said at least one acceleration cell is such that the particles emitted from said air outlet port of said cell impinge said substrate at a generally non-perpendicular angle.

51. A system according to claim 34 wherein a plane containing said air outlet port of said acceleration cell makes an angle of between about 60 and about −60 degrees with respect to the normal to a plane of said substrate, said plane of said substrate being the plane being coated.

52. A method for coating a large-area substrate, said method including the steps of:
i. positioning the substrate in a coating chamber;
ii. accelerating charged resin particles through an air outlet port of at least one acceleration cell, the acceleration cell being constructed as described in claim 1, the particles impinging and depositing on a wide swath of the substrate, the particles moving with a velocity of at least 0.1 m/s as they exit the air outlet port; and
iii. melting the deposited resin particles, thereby coating the substrate.

53. A method for coating according to claim 52 wherein said positioning step includes positioning a web-like substrate that is moving through the coating chamber.

54. A method for coating according to claim 52 wherein the particles of said accelerating step coat continuous wide swaths of a continuously moving substrate.

55. A method for coating according to claim 52 wherein said accelerating step further comprises the step of attracting the charged particles toward the substrate.

56. A method for coating according to claim 52 further comprising a second accelerating step where said first accelerating step accelerates particles having diameters equal to or less than a predetermined diameter and said second accelerating step accelerates particles having diameters greater than the predetermined diameter.

57. A method according to claim 56 wherein the predetermined diameter is 5 microns.

58. A method for coating according to claim 52 wherein the particles exit the air outlet port with a velocity of at least 0.5 m/s.
